(19) United States
(12) Patent Application Publication
(10) Pub. No.: US 2012/0070051 A1
(43) Pub. Date: Mar. 22, 2012

(54) Ultrasound Browser

(75) Inventors: Nicole Vincent, Paris (FR); Arnaud Boucher, Orry La Ville (FR); Philippe Arbeille, Joue Les Tours (FR); Florence Cloppet, Paris (FR)

(73) Assignee: UNIVERSITE RENE DESCARTES, Paris Cedex 06 (FR)

(21) Appl. No.: 13/147,559

(22) PCT Filed: Feb. 9, 2010
(86) PCT No.: PCT/FR10/50215

§ 371 Date: Nov. 29, 2011

(30) Foreign Application Priority Data
Feb. 13, 2009 (FR) 09 50953

(51) Int. Cl. G06K 9/00

(52) U.S. Cl. 382/131

(57) ABSTRACT

The invention relates to a method for processing image data, comprising the steps of: receiving a first set of ultrasound image data representing a given volume, said set being organized into first planes sharing a common segment; and, on the basis of the first data set, reconstructing a second set of image data representing at least partially the given volume, said second set being organized into second planes parallel to each other.

The present invention relates to the field of image processing, and more particularly to the field of medical ultrasound imaging.

There are existing ultrasonographs which render two-dimensional images, for example of patient organs. These systems require a specialist on site with the patient to be examined. Indeed, only the specialist is able to direct the probe to find a view enabling him or a physician to make a diagnosis. When such a specialist is not available, the patient must be transferred, which is costly and difficult.

There are also existing ultrasound systems that are three-dimensional. In such systems, an ultrasound probe is moved all around the patient to capture a representation of the examined volume. The three-dimensional navigation function only exists on instruments dedicated to this application. Currently, such systems are rare and are very high in price. This therefore limits their use: these systems cannot be installed in small hospitals or in isolated clinics, for example.

In addition, the 3D (three-dimensional) technology cannot be adapted to existing 2D (two-dimensional) devices. Upgrading to such a technology thus represents a huge investment, as it involves replacing all the imaging equipment.

In applications where the data acquisition occurs remotely to the place of diagnosis, the prior art devices also have numerous disadvantages.

In known 3D systems, the data volume is very high, because these systems are intended to reconstruct the entire volume in question. Large communication channels must therefore be provided. This makes these systems incompatible with critical applications, such as space applications for example.

In such applications, an astronaut may need to acquire the data himself, for example by applying a probe on an organ to be diagnosed. The data are then sent to the Earth for analysis and diagnosis establishment. Under these conditions, several requirements need to be reconciled: to communicate as little information as possible while still communicating enough to allow a physician to make the diagnosis, or to browse the received data in order to choose the most appropriate view.

Known 2D systems are inapplicable in such situations, because they imply a judicious choice of the appropriate view for diagnosis at the time the data is acquired.

The present invention improves this situation.

For that purpose, according to a first aspect of the invention, there is provided a method for processing image data, comprising the steps of:
receiving a first set of ultrasound image data representing a given volume, said set being organized into first planes sharing a common segment;
on the basis of the first data set, reconstructing a second set of image data at least partially representing the given volume, said second set being organized into second planes parallel to each other.

This method allows interpreting an ultrasound examination done remotely, for example by using a 2D probe holder. The expert has the possibility of browsing, remotely or at a later time (after the patient leaves), the volume of 2D ultrasound images captured by the probe as it is moved over the patient.

Data is acquired in a very simple manner, while allowing the correction of any manipulation inaccuracies by navigating through a smaller volume of data than in a 3D system.

The passage to parallel planes allows easier storage and computation than in the prior art. In this manner the invention allows completely unrestricted navigation within a block of ultrasound images.

In addition, the present invention does not require significant investment because it can be used with existing 2D ultrasound probes.

In an advantageous use, the images are captured by a “tilting” probe holder. Such a probe holder allows rotating the probe around a point on the surface where the probe is placed. With such a probe holder, a sequence of regular images centered on the initial position of the probe is obtained, even when manipulated by a non-expert. An approximate localization is compensated for by the possibility of capturing data from neighboring areas, allowing the expert to make a reliable diagnosis. According to the invention, there is greater tolerance for inaccuracy in the probe positioning than in the prior art, because navigating through the volume enables a proper repositioning relative to the organ to be viewed in order to detect a possible pathology. In addition, the navigation allows freer movement, more precise focusing on the target, and an examination from all points of view. The physician is thus assured of having access to all possible views.

This therefore provides access to 3D navigation functionalities from any 2D ultrasonograph. The present invention can be installed onto any existing 2D ultrasonograph.

Advantageously, to further reduce the volume of data to be processed, a region of interest can be selected within the given volume, with the second data set representing this region of interest.

In some advantageous embodiments, each second plane is reconstructed by associating segments extracted from the first planes, and the extracted segments belong to a same plane perpendicular to the bisecting plane of those of the first planes which form the largest direct angle.

This arrangement allows changing from planes in angle sector to parallel planes, avoiding overly complex calculations while maintaining sufficient precision for navigating through the data.

Navigation can be achieved by arranging it so that any plane of the portion of the given volume is reconstructed by juxtaposing a set of intersection segments of this plane with the second planes.

In addition, the reconstructed planes can have interpolated segments between the extracted segments.

Another object of the present invention is a computer program comprising instructions for implementing the method according to the invention when the program is executed by a processor, for example the processor of an image processing system. The present invention also provides a computer-readable medium on which such a computer program is stored.

According to a second aspect of the invention, there is provided a system for processing ultrasound image data, comprising:
means for receiving a first set of ultrasound image data representing a given volume, said set being organized into first planes sharing a common segment;
first storage means for the processing of these data; and
a processing module adapted to reconstruct, from the first data set, a second set of image data at least partially representing said given volume, said second set being organized into second planes parallel to each other.

In addition, the system can comprise second storage means for receiving the second data set, and the processing module can be adapted to reconstruct any plane of said portion of the given volume by juxtaposing a set of intersection segments of said plane with the second planes.

In particular embodiments, the system can comprise display means for displaying said any plane, and/or communication means for transmitting the second set of image data.

The advantages obtained by the computer program and the image data processing system, as briefly described above, are at least identical to those mentioned above in relation to the image data processing method according to the invention.

Other features and advantages of the invention will become apparent from the following detailed description, and the accompanying drawings in which:

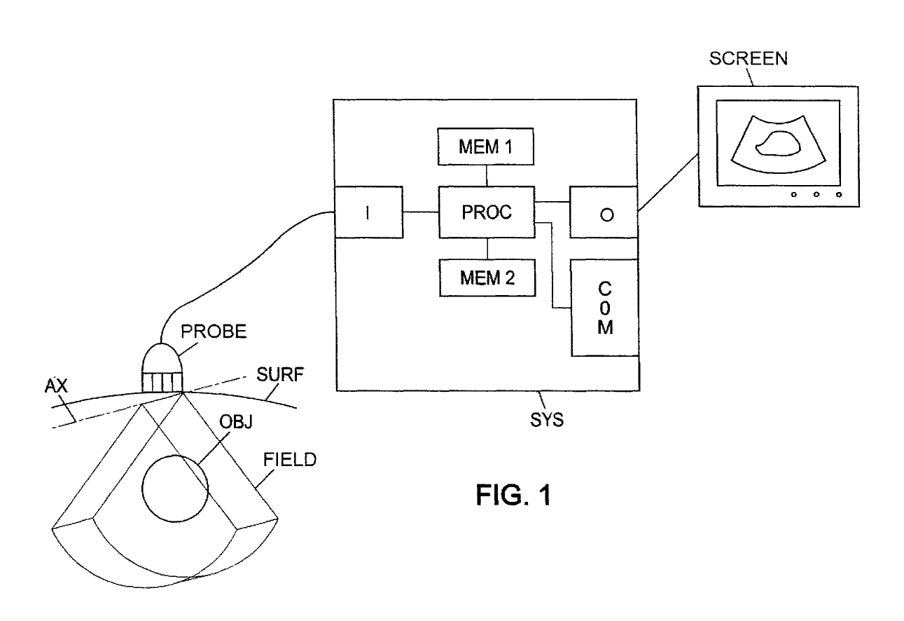

FIG. 1 illustrates the image processing system according to an embodiment of the invention in a context for its use,

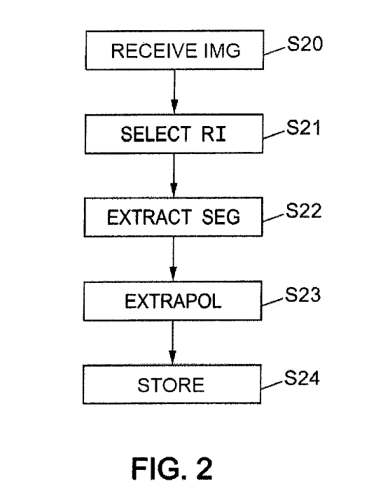

FIG. 2 illustrates steps of an embodiment of the method according to the invention,

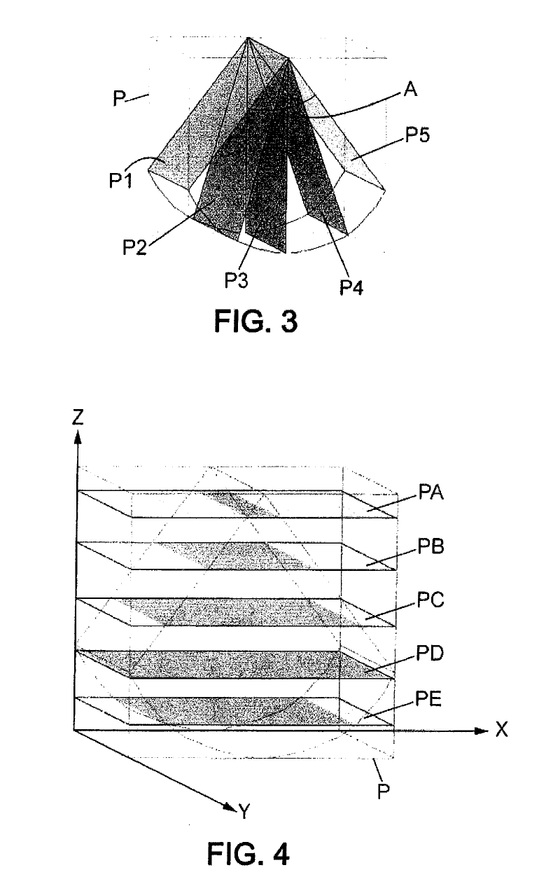

FIGS. 3 to 6 illustrate various representations of a volume examined by ultrasonography and reconstructed by the method,

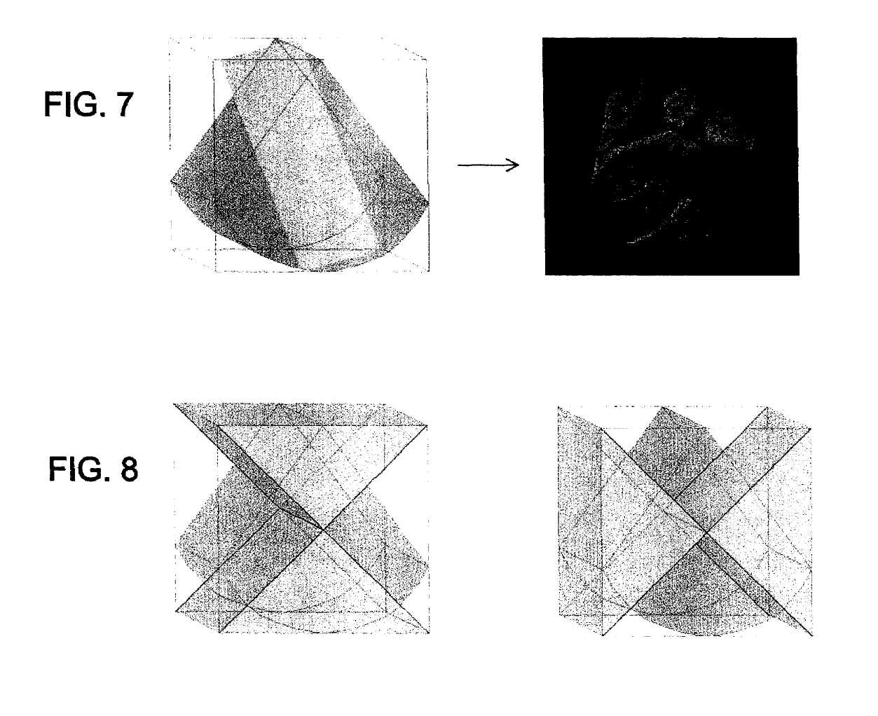

FIG. 7 illustrates a view of the examined volume,

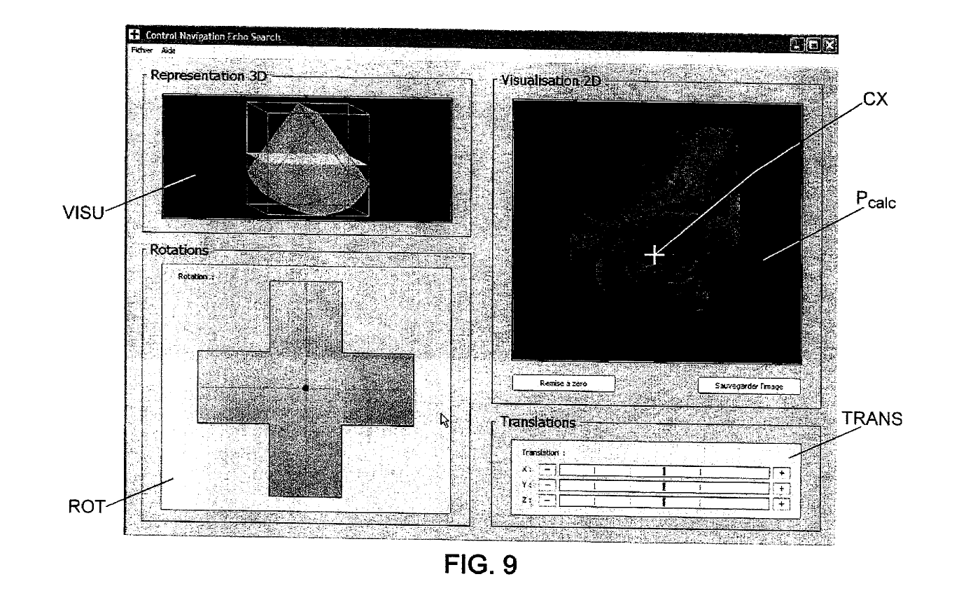

FIG. 8 illustrates the different cases for a rotation of the viewing plane,

FIG. 9 illustrates a human machine interface according to an embodiment of the invention.

A 3D view is often represented by a succession of contiguous 2D images. Such a succession comprises a set of images representing parallel or sector slices of the considered volume.

In order to offer smooth navigation in real time, limits must be established for the volume of data to be processed. Indeed, image processing requires the use of a large amount of random access memory (RAM) of the computer doing the processing.

Smooth navigation allows refreshing the images displayed on the screen sufficiently quickly when the probe is moved. This enables a navigation generating a succession of images without discontinuities or instabilities (for example, a refresh rate (frame rate) of 5 images per second provides satisfactory navigation comfort).

In the following description, the viewing is presented in two steps: first, the creation of a volume representing the object being examined by ultrasound, then the navigation through this volume.

The method according to the invention allows performing the following tasks:
selecting a zone of interest,
developing the matrix of image points of the sector volume of images,
navigating within this volume.

The first two points constitute a preprocessing phase and must therefore not exceed a certain calculation time. Indeed, a wait of more than 2 or 3 minutes seems too long to the user. One advantageous embodiment aims for a preprocessing that does not exceed 1 minute.

Whether it is for the calculation time or for a RAM limit, the volume of processed data should not exceed a certain threshold, which obviously depends on the properties of the machine on which the method will be implemented. To improve the possibilities, we have chosen to store and use the data in a fragmented manner, as the calculated volume would be too dense to be processed as a whole.

One goal of the invention is therefore to reconcile two contradictory factors: maximizing the quality of the produced image and minimizing the calculation time.

A general context for implementing the invention is described with reference to FIG. 1. An ultrasound probe PROBE is placed on the surface SURF under which is located an object OBJ to be viewed, such as a patient's organ for example. As a further example, the probe is supported by a “tilting” robot. The probe is placed at a point of the surface and then rotated around the axis AX of this surface. The probe captures a set of planes forming the viewing field FIELD. Of course, the probe movement is such that the object to be viewed is located within the field.

The probe sends the images to the processing system SYS, which carries out the method as described below. The system can be coupled to a screen SCREEN for viewing and possibly navigating through the volume of data delivered by the system. It may also be coupled to another remote navigation system, via a communication port COM.

The system comprises an input I for receiving the image data, and a processor PROC for processing the data. It additionally comprises memories MEM1 and MEM2 for storing information. For example, MEM1 is the RAM of the system and MEM2 is a durable storage medium. Lastly, the system comprises outputs O and COM which are respectively a direct output, for example to the screen, and a communication port (wired or wireless).

The system executes a computer program which can be implemented as shown in the flow chart in FIG. 2 and as described in the embodiment of the method given below.

FIG. 2 summarizes the steps of the embodiment of the method according to the invention which will now be described in further detail.

In a first step S20, a set of planes captured by the probe is obtained. Then, in step S21, a region of interest is selected in the images in order to focus the processing on this region. As will be seen later, in order to change from a sector-based representation of the region of interest to a representation in parallel planes, advantageously chosen segments are extracted in step S22 from the captured images.

From these segments, an extrapolation is performed in step S23 to reconstruct the parallel planes. This set of planes is then stored in memory in step S24 for transmission, saving, or navigation.

These different steps are further detailed below.

### Selecting a Zone of Interest

The probe, which captures the images, remains at a fixed point and scans by capturing a bundle of regularly spaced images, i.e. with constant angles between two consecutive images.

Software for navigating within an angular section has already been developed, but such software does not process the entire captured volume. It limits the processing to a parallelepiped included within the angular sector. On the contrary, here, all the data are taken into account, and the parallelepiped encompassing the provided angular sector is reconstructed.

FIG. 3 illustrates such a parallelepiped P. This figure shows the planes issued from the probe P1, P2, P3, P4, P5. They form an angular sector of angle A.

Our main objective is to obtain smooth navigation, so the volume of information to be processed must be as small as possible. Therefore, only the zones of interest in the image are retained.

This phase is done manually, for example by selection on a screen using a mouse or stylus, for the first image in the series based on a default selection which can be confirmed or modified by the user, then automatically for all the other images in the sequence.

### Refining the Volume

To refine the volume in order to enable spatial navigation, good memory management must be associated with a reconstruction that can be put to use effectively.

A volume based on Cartesian coordinates system (x,y,z) respectively representing width, length, and height, provides a simple view allowing optimal calculation times during navigation.

For good memory management, the volume will not be stored and used in its entirety, but will be divided up. This information will be thus organized as a succession of images, each representing an “altitude” within the volume. Such an organization is illustrated in FIG. 4. The parallelepiped P can be seen in this figure. Here, the volume is represented by the planes PA, PB, PC, PD, PE, distributed parallel along the z axis. The coordinates system (x,y,z) is such that the plane (y,z) is parallel to the bisecting plane of planes P1 and P4 in FIG. 3.

Using a succession of contiguous parallel images to develop the volume simplifies the processing compared to the case of angular images where the Cartesian coordinates of the points are not regularly distributed in the space.

To construct each of the new images (i.e. the planes PA, . . . , PE), the set of images in the angular series is inspected. From each of these images, the line segment corresponding to the height (on the z axis) of the axial slice is extracted while taking into account the offset caused by the angle of the plane.

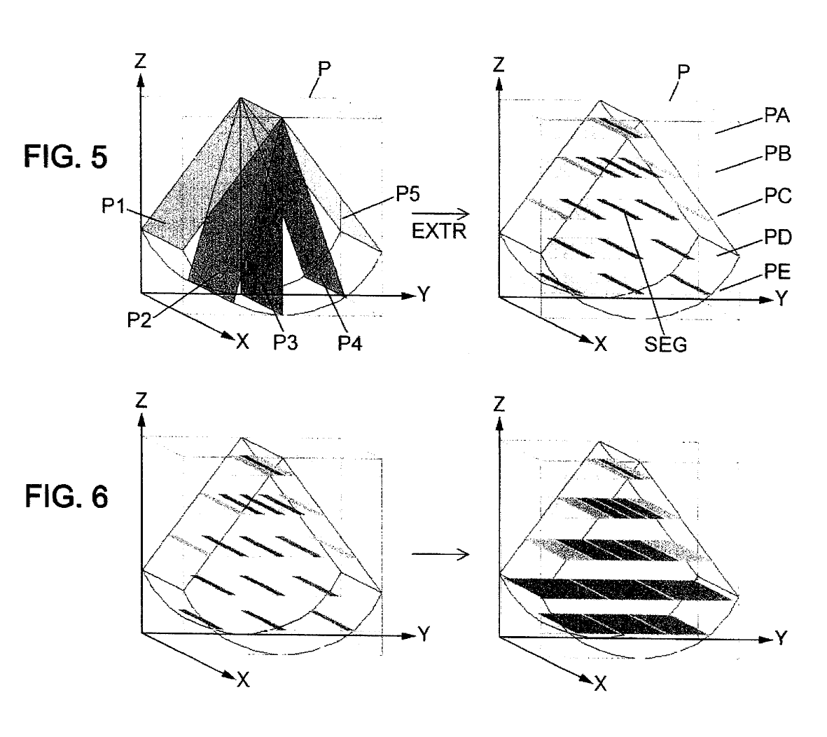

Such an extraction is illustrated in FIG. 5. The extracted segments SEG are juxtaposed, but the space between them varies according to the height of the axial section being processed: the further from the base of the angular section, the wider the spacing. This spacing depends on the number of images in the acquisition set, as well as the angle chosen during the data capture.

If the space between the first and the last straight line is less than the number of straight lines (which occurs at the apex of the angular section), the median straight lines of each set of superimposed straight lines are selected. If the space is greater than the number of straight lines, the spaces are filled with the closest non-zero value in the longitudinal slice.

This arrangement of the extrapolation is illustrated in FIG. 6.

### Navigation

The navigation must allow providing a plane view in 3D space with any possible position (depth, angle, etc.) as illustrated in FIG. 7. In this figure, the viewing plane is any plane, i.e. it may not correspond to one of the planes PA, . . . , PE.

This navigation is based on varying 5 parameters, defining 2 rotations (along the x axis or along the y axis) and 3 translations (in the direction of the x axis, the y axis, or the z axis).

To generate the preview, all the images representing an axial slice are scanned, and one or more straight lines are extracted from each image. These straight lines juxtaposed atop one another generate the image offered to the user.

Rotation around the x axis will modify the used slice, or the choice of straight line extracted from a given slice for each of the columns in the resulting image. Rotation around the y axis has the same effect for the rows. From a mathematical point of view, the problem is highly symmetrical.

From the point of view of computer processing, several cases can be distinguished for using parameters varying over a finite interval [−1,+1], rather than conventionally using the tangent of the angle characterizing the viewing plane in the coordinates system, which varies over an infinite domain. It is therefore possible to differently process the planes with small slopes and the planes with the highest slopes (less than or greater than a 45° angle to the horizontal). FIG. 8 illustrates the two distinguished cases.

In this manner, the coefficient of the equation representing the slope is still between −1 and 1.

Translations are achieved by incrementing the respective coordinates of the points, which translates the plane of observation in the desired direction within the volume.

Rotations are done from the center of the reconstructed image. A cross marks the central point of rotation of the navigator. Once the organ is centered on this cross (by translation Ox Oy and Oz) the 2 rotations will allow scanning the entire organ without any risk of losing it.

Once the preview is calculated, interpolation is applied to supplement the calculated points and produce a quality image. This operation of adding details to the image is performed only if the user remains at the same position for more than a half-second. The initial viewing is sufficient and ensures smoother navigation.

To add details to the image, a new row is included between the rows extracted from two different slices. The pixels in this new row are calculated by averaging the 8 neighboring non-zero pixels.

### Results

The following description presents some results obtained by executing the above method on a computer having a 3 GHz processor and 512 Mb of RAM.

The volumes of data used are as follows:
100 images of 140×140 (2 million pixels),
170 images of 235×235 (9.3 million pixels),
180 images of 245×245 (10.8 million pixels).

For the preprocessing, the results depend on the density of the processed images as well as the density of the produced images. This is why the volume is calculated at a limited and configured density.

The density of the images that are input depends on the choices made by the user who extracted these images from the ultrasonograph.

It is not necessary to have a number of pixels provided by the ultrasonograph that is much greater than the number of voxels produced by the present method. As the produced volume is less than 10 million pixels, the number of provided pixels (equal to the number of images multiplied by their height multiplied by their width in pixels) must be in the same order of magnitude, after recentering the region of interest.

Tests have shown that the preprocessing takes less than a minute if the set of images provided by the ultrasonograph does not exceed 10 million pixels. The number of images is an important factor in the calculation time. The number must not exceed 100 to maintain good performance (which gives, for example, 95 images of 320×320 pixels or 60 images of 400×400 pixels).

TABLE 1
Preprocessing time

| Number of input | Generated volume | Preprocessing |
|---|---|---|
| images for 10 | (in millions of | time (in |
| million pixels | pixels) | seconds) |
| 60 | 2 | 30 |
| 95 | 2 | 40 |
| 60 | 9.3 | 55 |
| 95 | 9.3 | 65 |
| 60 | 10.8 | 66 |
| 95 | 10.8 | 75 |

During navigation, the frame rate is highly dependent on the density of the volume. For 2 million pixels, it varies between 17 fps and 28 fps. For 9.3 million pixels, it varies between 7 fps and 11 fps, which is sufficient for smoothly navigating.

TABLE 2
Smoothness of navigation

| Definition of volume | Frame rate |
|---|---|
| (in millions of pixels) | (in images per second) |
| 2 | 18 to 28 |
| 4.2 | 11 to 16 |
| 6.6 | 8 to 12 |
| 9.3 | 7 to 11 |
| 10.8 | 4 to 6 |

The results in terms of preprocessing time and smoothness are very good. As computers are more and more powerful, the sharpness of the processed image as well as the sharpness of the navigation preview will become more and more accurate. The limits set on the precision of the provided images as well as of the produced volume are therefore constantly evolving.

### Human Machine Interface

To ensure adaptability and intuitive use of the interface for someone accustomed to working with an ultrasound probe, a particular interface, illustrated in FIG. 9, was developed.

The interface thus comprises the calculated slice plane Pcalc, with tools ROT and TRANS for modifying the 5 navigation variables (3 translations and 2 rotations), as well as visualization VISU of the position of the observed plane in 3D space. A cross CX marks the central point of rotation of the browser. Once the organ is centered on this cross (by translation Ox Oy Oz), the 2 rotations will allow scanning the entire organ with no risk of losing it.

It is possible to select the number of pixels composing the produced volume, in the software options. The user can thus adjust the calculation time to the used machine, as well as to the desired level of detail in the results.

An image “decimator” can be added, for reducing the size and number of the input images if they are too dense in order to avoid processing an excessive number of pixels.

The software can be programmed in the Java programming language so it can be used on any type of machine.

1. A method for processing image data, wherein it comprises the steps of:
receiving a first set of ultrasound image data representing a given volume, said set being organized into first planes sharing a common segment, and
reconstructing, on the basis of the first data set, a second set of image data at least partially representing said given volume, said second set being organized into second planes parallel to each other.

2. A method according to claim 1, wherein it additionally comprises the step of:
selecting a region of interest in the given volume,
and wherein the second data set represents this region of interest.

3. A method according to claim 1, wherein:
each second plane is reconstructed by associating segments extracted from the first planes, and wherein
the extracted segments belong to a same plane perpendicular to the bisecting plane of those of the first planes which form the largest direct angle.

4. A method according to claim 1, wherein it additionally comprises:
reconstructing any plane of the portion of the given volume by juxtaposing a set of intersection segments of said plane with the second planes.

5. A method according to claim 1, wherein the reconstructed planes comprise interpolated segments between the extracted segments.

6. A computer program comprising instructions for implementing the method according to claim 1, when the program is executed by a processor.

7. A system for processing image data, wherein it comprises:
means for receiving a first set of ultrasound image data representing a given volume, said set being organized into first planes sharing a common segment,
first storage means for the processing of these data, and
a processing module adapted to reconstruct, from the first data set, a second set of image data at least partially representing said given volume, said second set being organized into second planes parallel to each other.

8. A system according to claim 7, wherein it additionally comprises second storage means for receiving the second data set, and wherein the processing module is additionally adapted to reconstruct any plane of said portion of the given volume by juxtaposing a set of intersection segments of said plane with the second planes.

9. A system according to claim 7, wherein it additionally comprises communication means for transmitting the second set of image data.
